(19) United States
(12) Patent Application Publication
(10) Pub. No.: US 2005/0046742 A1
(43) Pub. Date: Mar. 3, 2005

(54) Image signal processing circuit

(76) Inventor: Satoru Saito, Fujioka-shi (JP)

Correspondence Address: Jonathan P. Osha;Osha & May L.L.P., Suite 2800, 1221 McKinney St., Houston, TX, 77010, US

(21) Appl. No.: 10/932,998

(22) Filed: Sep. 2, 2004

(30) Foreign Application Priority Data
Sep. 2, 2003 (JP) JP2003-310715

(51) Int. Cl. H04N 11/20

(52) U.S. Cl. 348/452; 348/448

(57) ABSTRACT

A background color data output determination section outputs a control signal for selecting background color data until a predetermined number of vertical synchronization signals is counted after the start of IP conversion. Based on the control signal supplied from the background color data output determination section, a buffer data/background color data selection section selects a background color for output, so that the background color is output and displayed on the screen when a progressive image signal based only on an input image signal is not prepared at the time of actuation of power source, for example.

The entire disclosure of Japanese Patent Application No. 2003-310715 including specification, claims, drawings and abstract is incorporated herein by reference in its entirety.

### BACKGROUND OF THE INVENTION

1. Field of the Invention

The present invention relates to an image signal processing circuit which performs image signal processing for converting an interlace image signal into a progressive image signal, so-called “IP conversion”.

2. Description of Related Art

Conventional television signals include an interlace image signal of the NTSC system or the like. Such an interlace signal comprises, for one frame of a television signal, odd field signals corresponding to odd-numbered horizontal scanning lines and even field signals corresponding to even-numbered horizontal scanning lines. On the television screen, the odd field signals and the even field signals are sequentially displayed in either of these two fields, namely in alternate scanning lines offset from each other by one horizontal scanning line. In the NTSC system, display of one field lasts 1/60th of a second, and display of one frame is therefore completed in 1/30th of a second.

Here, the resolution of the television screen can be increased if the signals concerning all the horizontal scanning lines are replaced by new image signals at each display which occurs every 1/60 seconds.

For this purpose, an apparatus has been known which uses interpolation to convert an interlace image signal for all the horizontal scanning lines into a progressive image signal, and creates a display accordingly. More specifically, with regard to a horizontal scanning line for which no corresponding interlace signal exists, interpolation is performed using signals in the adjacent horizontal scanning lines in the corresponding field, or using signals in the corresponding scanning line in the previous and following fields, thereby generating a signal for the target scanning line, which is a progressive image signal. This progressive signal enables high resolution display which can be observed clearly even in a large size screen.

The IP conversion for converting an interlace image signal into a progressive image signal as described above is disclosed in publications such as Japanese Patent Laid-Open Publications No. 2002-185933, No. 2002-112202, No. 2002-64792, No. 2001-339694, and others.

The above related art, however, suffers from a problem that an unwanted image is briefly, but undesirably, displayed when the power source is actuated. This occurs because at the start of the IP conversion process the image memory is filled with meaningless or random data, and a desirable image cannot be displayed until this data is replaced with a progressive image signal obtained by the newly-input interlace image signal. More specifically, because inter-field interpolation, motion detection based on the image data for a plurality of fields, and other process are performed in the IP conversion, a certain amount of time is required before the progressive image corresponding to one frame can be obtained, and real display cannot be performed during that initial period.

### SUMMARY OF THE INVENTION

According to one aspect of the present invention, a background color signal which is previously prepared is supplied as an output signal until a progressive image signal can be obtained based only on an input interlace signal after start of an conversion process, and, once such a progressive signal is available, an output signal is switched to a progressive image signal which is generated by a conversion process. It is therefore possible to prevent generation and output of an image based on random or indefinite data when power is turned on.

Further, because the timing for switching from the background color data to normal data is determined based on the count of a vertical synchronization signal, sufficient input data can be obtained and accurate timing for obtaining a progressive signal can be detected effectively with a simple structure.

Also, as data defining a single color are used as the background color data, a very simple structure can be employed for outputting the background color data.

In addition, by counting a vertical synchronization signal after start of the IP conversion, the background color data can be switched at an appropriate timing.

### BRIEF DESCRIPTION OF THE DRAWINGS

A preferred embodiment of the present invention will be described in further detail based on the following figures, wherein:

FIG. 1 is a view showing a conceptual structure for IP conversion;

FIG. 2 is a view showing a hardware structure for IP conversion;

FIG. 3 is a view showing a data conversion state; and

FIG. 4 is a flowchart showing a background color data switching operation.

### DETAILED DESCRIPTION OF PREFERRED EMBODIMENT

A preferred embodiment of the present invention will be described in further detail with reference to the accompanying drawings.

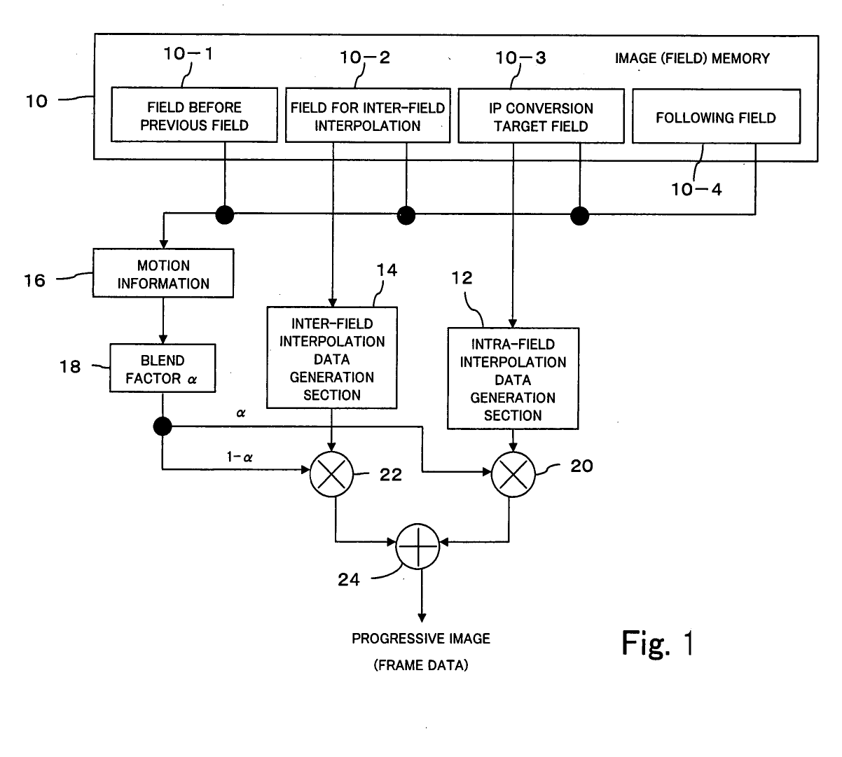

FIG. 1 schematically shows outline of an interpolation process according to one embodiment of the present invention. An image memory 10 sequentially stores an interlace image signal corresponding to four fields. In this example, a memory area 10-1 stores data of the field which appeared earliest, and memory areas 10-2, 10-3, and 10-4 sequentially store data of the subsequent fields in this order. The field concerning the memory area 10-3 is a target field of IP conversion. Further, the memory areas 10-1 to 10-4 sequentially store an interlace signal, and therefore alternately store data of the odd number field and data of the even number field.

The data stored in the memory area 10-3, which are data of the IP target field, are supplied to an intra-field interpolation data generation section 12. The intra-field interpolation data generation section 12 outputs, as output data for a horizontal scanning line (horizontal line) having no corresponding data, data for the previous horizontal line once again. Here, it is also possible to generate image data for the target horizontal line based on data for the adjacent horizontal lines above and below the target line, if the circuit structure permits.

The data stored in the memory area 10-2 concerning the field coming just before the IP target field (that is, the previous field) are supplied to an inter-field interpolation generation section 14. Because this memory area 10-2 stores data concerning the target horizontal line to be interpolated, such data are output as they are, for example.

The data stored in the memory areas 10-1 to 10-4 are supplied to a motion information detection section 16. The motion information detection section 16 compares the data of the four fields and detects motion of the image based on the matching degree of images among the fields. Normally, an amount of motion is detected based on the matching degree of pixel data for two odd fields and the matching degree of pixel data for two even fields. The result of detection is supplied to a blend factor α generation section 18, which generates a blend factor α which becomes greater as the motion is bigger in accordance with a predetermined method.

The data subjected to intra-field interpolation in the intra-field interpolation data generation section 12 are supplied to a multiplier 20, where a blend factor α is multiplied with the data of the target horizontal line obtained by the interpolation. On the other hand, the data in the inter-field interpolation data generation section 14 are supplied to a multiplier 22, where (1-α) is multiplied with the supplied data. The outputs from these multipliers 20 and 22 are supplied to an adder 24, where an adding process is performed with regard to the data for the horizontal line to be interpolated, and a progressive image signal which has been interpolated are output.

Although in the above example the original data of the horizontal line which do not require processing also pass through the intra-filed interpolation data generation section 12 or the like, such data can also be temporarily separated and inserted back later.

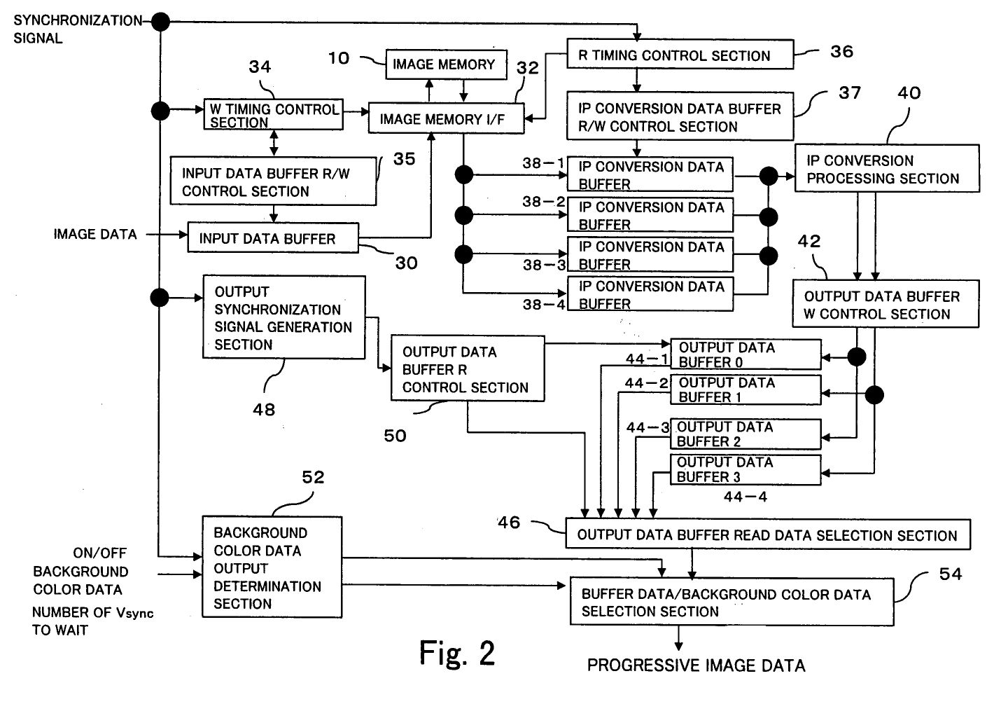

FIG. 2 shows a detailed structure of an apparatus for performing the above operation. Image data are written into the image memory 10 via an input data buffer 30 and through an image memory I/F 32. Also, a horizontal synchronization signal (Hsync) indicative of the timing in the horizontal and vertical directions with regard to the image data is supplied to a W timing control section 34. The W timing control section 34 controls writing timing and reading timing of the image data into and from the input data buffer 30 via an input data buffer R/W control section 35. The W timing control section 34 also controls the image memory I/F 32 to control the writing timing of the image data transmitted from the input data buffer 30 into the image memory 10.

The synchronization signal (horizontal synchronization signal) is also supplied to an R timing control section 36. The data stored in the image memory 10 are supplied to four IP conversion data buffers 38 via the image memory I/F 32. Specifically, data for the four fields are stored in the image memory 10, as shown in FIG. 1, and are supplied to the corresponding one of the four IP conversion data buffers 38, respectively. The R timing control section 36 controls reading of data by the image memory I/F 32 and also controls writing of the data into the IP conversion data buffers 38 via an IP conversion data buffer R/W control section 37.

The data in the IP conversion data buffer 38 are then supplied to an IP conversion processing section 40, where an operation for interpolation is performed. More specifically, the IP conversion processing section 40 performs processes such as intra-field interpolation, inter-field interpolation, calculation of a blend factor, generation of interpolation data, and so on. As a result of these processes, data are generated for the horizontal line having no corresponding data, and both the interpolated data and the original data for the horizontal line are supplied, via the output data buffer W control section 42, to four output data buffers (0) 44-1 to (3) 44-4. In FIG. 2, one of the two lines extending from the IP conversion processing section 40 corresponds to data of a horizontal line which have been interpolated and the other corresponds to the original data for the horizontal line. Then, the data for the two horizontal lines (one for the interpolated data and the other for the original data) which are output from the output data buffer W control section 42 are sequentially written into a pair of the output data buffer (0) 44-1 and the output data buffer (1) 44-2 and a pair of the output data buffer (2) 44-3 and the output data buffer (3) 44-4.

The output from these four output data buffers (0) 44-1 to (3) 44-4 are supplied to an output data buffer read data selection section 46.

Here, a synchronization signal on the input side is supplied to an output synchronization signal generation section 48, where an output synchronization signal (output horizontal synchronization signal) which is synchronous with an input synchronization signal and which has a frequency twice the input synchronization signal is generated. The output horizontal synchronization signal is supplied to an output data buffer R control section 50. The output data buffer R control section 50 controls the output timing of the output data from the output data buffers 44-1 to 44-4, and also controls selection performed by the output data buffer read data selection section 46. Consequently, the output data buffer read data selection section 46 outputs a progressive image data signal having a signal for every horizontal line, in synchronization with the output horizontal synchronization signal.

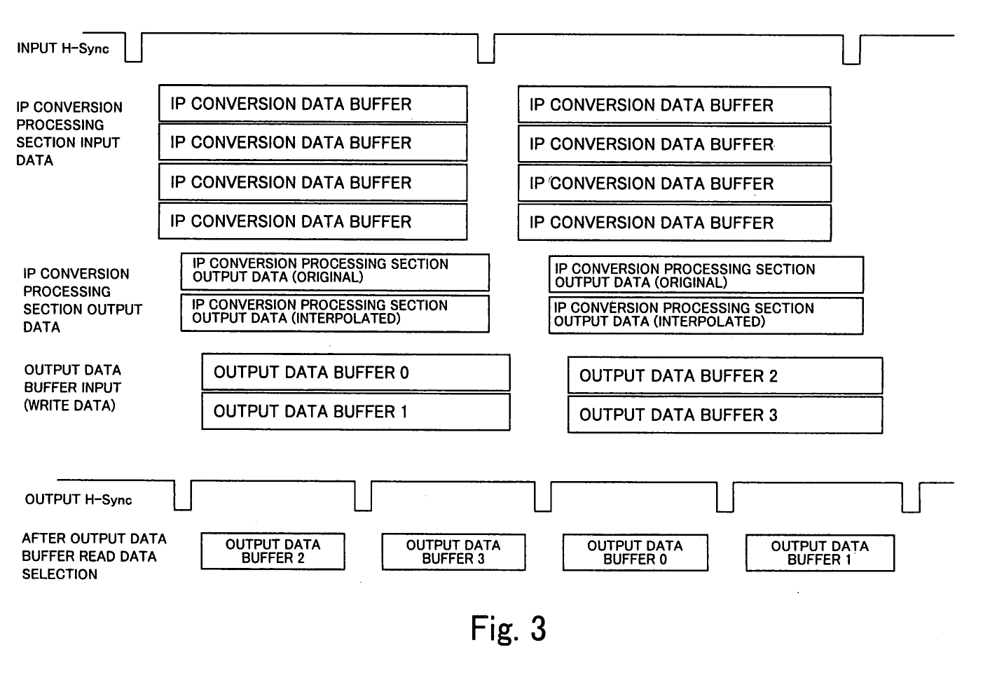

With reference to FIG. 3, movement of data will be described. Four-field information data are stored within the image memory 10, and data for one line are extracted from each field and supplied to the IP conversion data buffer 38. For example, data for the n-th line in the target field of IP conversion, data for the n-th line in the field before the previous field of the target field which are stored in the memory area 10-1, data for the (n+1)-th line (line for interpolation) in the previous field (the field coming just before the target field), and data for the (n+1)-th line in the field following the target field are supplied for storage into the four IP conversion data buffers 38, respectively. Then, IP conversion processing section 40 outputs the data for the n-th line in the target field (the original data) and the data for the (n+1)-th line (the interpolated data) obtained by interpolation in which the data subjected to intra-field interpolation (obtained from the previous line) and the data subjected to inter-field interpolation (obtained from the same line in the previous field) are proportionally distributed in accordance with the motion, and the output data are written into the output data buffers 44-1 and 44-2.

Then, the data written into the output data buffers 44-1 and 44-2 are sequentially output in accordance with an output horizontal synchronization signal. Here, writing of data into the output data buffers 44-1 and 44-2 as described above is performed during one horizontal period of an input horizontal synchronization signal (corresponding to two horizontal periods of an output horizontal synchronization signal), and, during this period, data which are written in the output buffers 44-3 and 44-4 are sequentially output. In this manner, data captured during one horizontal period of an input horizontal synchronization signal are processed and data corresponding to two lines are generated and written into the output buffer 44 during a period corresponding to two horizontal lines of an output horizontal synchronization signal. The data thus written in the output data buffer 44 are then output during the next period corresponding to two lines of the output horizontal synchronization signal.

With the above operation, a progressive image is generated from an interlace image signal, and then output.

Here, an input synchronization signal is also supplied to a background color data output determination section 52. The background color data output determination section 52 counts a vertical synchronization signal (Vsync) in the input synchronization signal. Further, a signal indicative of on/off of the progressive process which is supplied from an external microcomputer, background color data, and data concerning the number of vertical synchronization signals to wait are also supplied to the background color data output determination section 52.

At the time of starting the power source, for example, an appropriate interpolation process cannot be performed until image data corresponding to four fields are written in the image memory 10. Accordingly, during this period, the background color data output determination section 52 selects the background color data as an output and controls a buffer data/background data selection section 54 to output the background color data.

The background color data may be data of blue or black color determined by a signal which is supplied from a microcomputer. As described above, the buffer data/background color data selection section 54 outputs the background color data supplied from the background color data output determination section 52, rather than the output data from the output data buffer read data selection section 46. While data corresponding to each pixel are sequentially read from the output data buffer 44 during a predetermined period of an output horizontal synchronization signal, single background color data can be output in place of all these pixel data.

Further, the number of vertical synchronization signals to wait is supplied from the microcomputer to the background color data output determination section 52. When the count value for the vertical synchronization signals in the input synchronization signal reaches the number of vertical synchronization signals to wait, completion of output of the background color data is detected, and the buffer data/background data selection section 54 is switched so as to select data from the output data buffer read data selection section 46.

Thus, a progressive image signal which is generated by IP conversion is output from the buffer data/background color data selection section 54.

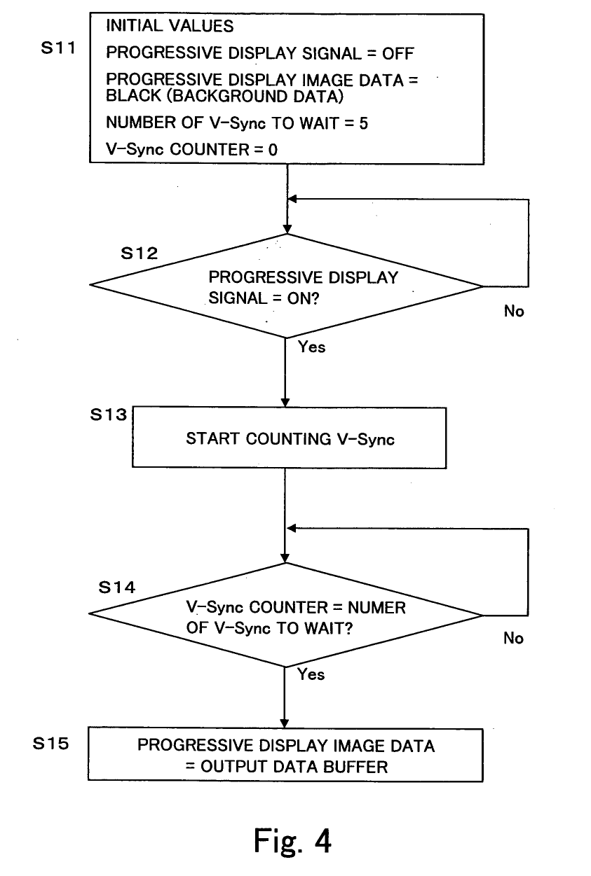

FIG. 4 shows a flowchart for a process operation performed by the background color data output determination section 52. Initially, values are set such that progressive display signal=off; progressive display image data=black (background color data); the number of vertical synchronization signals to wait=5; and vertical synchronization signal counter=0 (S11). It is then determined whether or not progressive display signal=ON (S12). If the determination is NO, the determination process at S12 is repeated, whereas if the determination is YES, counting of the vertical synchronization signal starts (S13). It is then determined whether or not the count value of the counter=the number of vertical synchronization signal to wait (S14). If the determination is NO, the determination process at step S14 is repeated. When the determination is YES, on the other hand, the background color data output determination section 52 instructs the buffer data/background color data selection section 54 to switch the output to the progressive image data supplied from the output data buffer 44 (S15).

In the above example, the number of vertical synchronization signals to wait which are supplied from the microcomputer is set to 5. This value is chosen because data corresponding to four fields are required for the interpolation operation as described above, the interpolation operation for four fields is necessarily completed when the number of vertical synchronization signals counted reaches 5, and the output data buffer 44 has therefore stored image data for output which are generated based on the input image data. An additional safety factor can be provided by setting a larger value to the number of vertical synchronization signals to be counted before switching.

Further, while in the above example, the image data and the background color data are switched immediately before they are output, it is also possible to supply the background color data, rather than the image data, to the IP conversion data buffer 38.

As described above, according to the present embodiment, the output of background color data continues until sufficient input data necessary for the interpolation have been input. As the background color data are displayed on the screen throughout that period, undesirable display of a random or cacophonic screen image can be prevented.

While the preferred embodiment of the present invention has been described using specific terms, such description is for illustrative purposes only, and it is to be understood that changes and variations may be made without departing from the spirit or scope of the appended claims.

1. An image signal processing circuit for converting an interlace image signal to a progressive image signal, wherein
until a progressive image signal obtained by conversion of only an input interlace image signal becomes available after elapse of a predetermined time period from the start of a conversion process for converting an input interlace image signal to a progressive image signal, a background color signal which is previously prepared is output as a progressive image signal, and, after a progressive image signal obtained based only on an input interlace image signal is available, a signal to be output is switched to a progressive image signal which is generated by the conversion process.

2. An image signal processing circuit according to claim 1, wherein
switching from a background color signal to a progressive image signal which is generated by the conversion process is performed at a time point when a count value obtained by counting a vertical synchronization signal in an input interlace image signal reaches a predetermined number.

3. An image signal processing circuit according to claim 2, wherein
the conversion process is performed using an interlace image signal for four fields.

4. An image signal processing circuit according to claim 3, wherein
the four fields are a target field, the field immediately preceding the target field, the field just before the field immediately preceding the target field, and the field immediately following the target field.

5. An image signal processing circuit according to claim 4, wherein
the conversion process is performed by detecting a motion from the interlace image signal for the four fields and obtaining a blend factor based on the detected motion, and performing weighted addition, in accordance with the blend factor, with respect to an image signal for a line to be interpolated, which is obtained by intra-field interpolation from an interlace image signal of the previous field and an image signal for the line to be interpolated, which is obtained by intra-field interpolation from an interlace signal of the target field, thereby obtaining image data for the line to be interpolated.

6. An image signal processing circuit according to claim 1, wherein
when the background color signal is output as a progressive image signal, the same data are output for all the pixel data.

7. An image processing circuit according to claim 5, wherein
when the background color signal is output as a progressive image signal, the same data are output for all the pixel data.

8. An image processing circuit according to claim 7, wherein
switching from a background color signal to a progressive image signal which is generated by the conversion process is performed at a time point when a count value obtained by counting a vertical synchronization signal in an input interlace image signal reaches a predetermined number.

9. An image processing circuit according to claim 8, wherein
the count value is 5.
